(19) United States
(12) Patent Application Publication
(10) Pub. No.: US 2019/0121669 A1
(43) Pub. Date: Apr. 25, 2019

(54) EXECUTING TASKS USING MODULAR AND INTELLIGENT CODE AND DATA CONTAINERS

(71) Applicant: AMERICAN EXPRESS TRAVEL RELATED SERVICES COMPANY, INC., New York, NY (US)

(72) Inventors: Rares Ioan Almasan, Phoenix, AZ (US); Rebecca L. Henry, Phoenix, AZ (US); Rahul M. Menon, Phoenix, AZ (US)

(73) Assignee: AMERICAN EXPRESS TRAVEL RELATED SERVICES COMPANY, INC., New York, NY (US)

(21) Appl. No.: 15/789,845

(22) Filed: Oct. 20, 2017

(51) Int. Cl. G06F 9/50; G06N 99/00

(52) U.S. Cl. CPC G06F 9/50; G06N 99/005

(57) ABSTRACT

Systems and methods for executing tasks using modular code containers, intelligent code containers and data containers are provided. The system may comprise a master coordinator configured to implement algorithmic intelligence, artificial intelligence, and/or machine learning to intelligently generate, store, maintain, and retrieve the modular code containers and data containers. The system may receive task requests having at least one feature comprising functional components and data components. The system may retrieve the code containers based on the functional components, and the data containers based on the data components. The system may generate a result set by executing code from the code container to process data from the data container.

### FIELD

The disclosure generally relates to computer tasks, and more specifically, to systems and methods for executing tasks using modular code, intelligent code and data containers.

### BACKGROUND

Business processes may rely on computer tasks to aide in data processing, statistics, analytics, and/or the like. The tasks may be configured to run on a variety of data sources across multiple platforms. The tasks and data sources may rely on a variety of technology resources including various technologies, systems, databases, and platforms. The tasks may implement scripts, code, API's, or the like configured to execute against the data sources to produce a task result. Typically, the scripts, code, or API's are manually coded, and the connection and association of data with the scripts, code, or API's is handled manually. Multiple tasks may implement the same scripts, code, or API's, and may utilize the same data sources. As such, in response to an update or change in a script, code or API, or to a data source, tasks typically need to be manually updated to ensure accuracy and continued availability. Moreover, the static and defined nature of the tasks, scripts, code, or API's; and/or data sources may cause inefficient resource utilization (e.g., with CPU, RAM, storage, etc.) and monetary waste due at least partially to the need for manual updating and association, and the overlap of scripts, code, or API's, and data sources between tasks.

### SUMMARY

Systems, methods, and articles of manufacture (collectively, the “system”) for executing tasks using modular code, intelligent code and/or data containers are disclosed. The system may receive a task request. The task request may comprise a feature having functional components and data components. The system may retrieve a code container based on the functional components. The system may query a data container environment, wherein in response to locating a data container based on the data components, the data inventory retrieves the data container. The system may generate a result set by executing code from the code container to process the data from the data container.

In various embodiments, the code from the code container corresponds to an application programming interface (API), a web service, a script, a microservice, and/or an executable file. The system may further query a database environment to retrieve stored data based on the data components in response to being unable to locate the data container based on the data components. The system may generate a second data container containing the stored data retrieved from the database environment.

In various embodiments, the data components may comprise data metadata indicating the data to be retrieved. The data container environment is queried based on the data metadata. The functional components may comprise code metadata indicating the code container to retrieve, and the code container is retrieved based on the code metadata. The system may further update at least one of the code container or the data container based on machine learning from generating the result set.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for executing tasks using modular code, intelligent code and data containers, in accordance with various embodiments; and

FIG. 2 illustrates a process flow for a method of executing tasks using modular code, intelligent code and data containers, in accordance with various embodiments.

### DETAILED DESCRIPTION

The detailed description of exemplary embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, the systems, methods, and articles of manufacture (collectively, the “system”) disclosed herein may provide “plug-and-play” connectivity between code elements and data elements used to execute various tasks. For example, the system may implement algorithmic intelligence, artificial intelligence, and machine learning capabilities in building, maintaining, and/or updating modular code containers, intelligent code containers and data containers, as discussed further herein. The plug-and-play connectivity between code elements and data elements allows for code elements and/or data elements to be executed and reused across multiple tasks, thereby at least partially reducing the amount of manual coding and association typically used in previous task environments. Similarly, technology and resource costs associated with the execution of tasks may be reduced due at least partially to the reusability, modularity and/or intelligence employed in storing, maintaining, updating, and/or associating the code elements and data elements. In that regard, the system may result in reductions to monetary costs associated with the unnecessary operation of system components and hardware, including for example, server costs, CPU costs, storage costs, memory costs, and/or the like.

The system further improves the functioning of the computer and/or networked environment. For example, by automating the execution of tasks and the association of code elements to data elements, as opposed to needing the user, developer, or the like to manually execute the tasks or manually code and associate the code elements and data elements, the user performs less computer functions and provides less input, which saves on data storage and memory, thus speeding processing in the computer and/or networked environment. The system may also identify available copies of data (e.g., data containers) that can be utilized and/or reused to fulfill a task. In response to a reusable data container being available, the data container will be used in the execution of the task. This may eliminate, or at least partially reduce, a need to query and return the same data multiple times to fulfill one or more tasks making use of the same data, thus increasing processing speed and saving processing times. The re-usability and plug and play capabilities may increase the ability for users to introduce an infinite number of permutations between the data and code at keystrokes. The master coordinator may also make use of artificial intelligence to identify appropriate and optimized utilization of the system resources to fulfill the task. For example, the master coordinator may, based on artificial intelligence, machine learning, or the like, determine that the task is more efficiently executed on a first server in comparison to a second server, that the amount of memory needed to execute the task comprises more or less than initially assigned, or the like. This optimized approach to system utilization may at least partially reduce task failures, thus making the system more robust and avoiding costly re-execution of tasks; enhance processing speeds; and/or ensure optimal use of available memory and storage.

As used herein, “electronic communication” means communication of at least a portion of the electronic signals with physical coupling (e.g., “electrical communication” or “electrically coupled”) and/or without physical coupling and via an electromagnetic field (e.g., “inductive communication” or “inductively coupled” or “inductive coupling”). As used herein, “transmit” may include sending at least a portion of the electronic data from one system component to another (e.g., over a network connection). Additionally, as used herein, “data” may include encompassing information such as commands, queries, files, data for storage, and the like in digital or any other form.

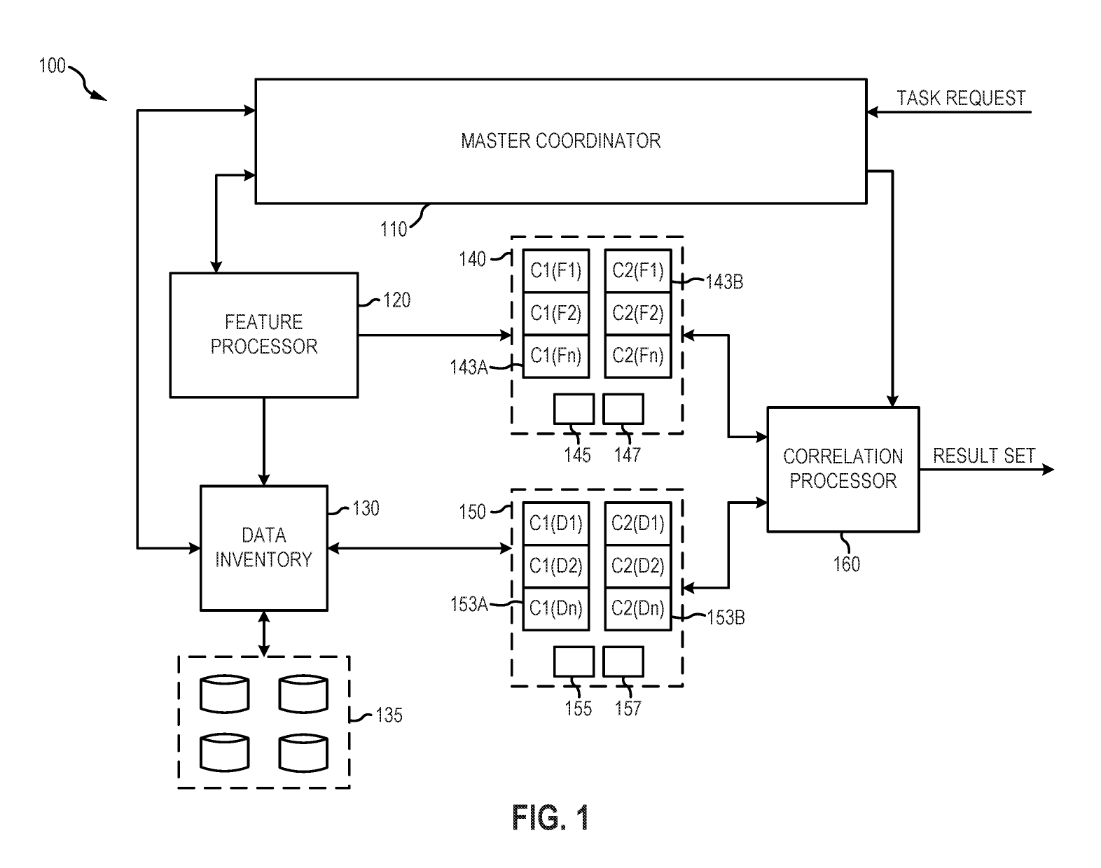

In various embodiments, and with reference to FIG. 1, a system 100 for executing tasks using modular code, intelligent code and data containers is disclosed. System 100 may be computer based, and may comprise a processor, a tangible non-transitory computer-readable memory, and/or a network interface, along with other suitable system software and hardware components. Instructions stored on the tangible non-transitory memory may allow system 100 to perform various functions, as described herein. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing. In various embodiments, system 100 may also leverage and/or implement automated continuous task triggering systems and/or health monitoring and task agility systems, such as those disclosed in U.S. Ser. No. 15/231,558 titled SYSTEM AND METHOD FOR AUTOMATED CONTINUOUS TASK TRIGGERING and filed on Aug. 8, 2016, and U.S. Ser. No. 15/334,577 titled SYSTEM AND METHOD FOR HEALTH MONITORING AND TASK AGILITY WITHIN NETWORK ENVIRONMENTS and filed on Oct. 26, 2016, the contents of each of which are herein incorporated by reference in their entirety.

System 100 may comprise one or more of a master coordinator 110, a feature processor 120, a data inventory 130, a database environment 135, a code container environment 140, a data container environment 150, and/or a correlation processor 160. The various systems, coordinators, environments, processors, inventories, databases, containers, and the like in system 100 may be in direct logical communication with each other via a bus, network, and/or through any other suitable means, or may be individually connected as described further herein. For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system. For example, and in accordance with various embodiments, the individual components of system 100 may be interconnected via a network.

As used herein, the term “network” may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, DISH NETWORKS®, ISDN, Digital Subscriber Line (DSL), or various wireless communication methods. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

In various embodiments, master coordinator 110 may be in electronic and/or logical communication with feature processor 120, data inventory 130, and/or correlation processor 160. Master coordinator 110 may comprise any suitable combination of hardware, software, databases, or the like. For example, master coordinator 110 may comprise a computer-based system, processor, or the like capable of receiving data, performing operations, monitoring the operation of various system 100 components, and/or instructing various system 100 components as discussed further herein. In that regard, master coordinator 110 may include one or more processors and/or one or more tangible, non-transitory memories and be capable of implementing logic. In various embodiments, master coordinator 110 may comprise a processor configured to implement various logical operations in response to execution of instructions, for example, instructions stored on a non-transitory, tangible, computer-readable medium. Master coordinator 110 may also provide machine learning, predictive analysis capabilities, and algorithmic and artificial intelligence capabilities, as discussed further herein.

In various embodiments, master coordinator 110 may be configured to receive a task request. Master coordinator 110 may be configured to instruct various processors, modules, and components of system 100 based on the task request, as discussed further herein. The task request may be received from a user input (e.g., via a user device), and/or through any other suitable input. The task request may also be generated by another system, or by master coordinator 110 (e.g., a monthly report or the like requiring the execution of tasks). The task request may comprise one or more tasks. Each task may comprise instructions to process data in system 100 such as, for example, during the creation and/or sending of data, formatting of data, statistical and/or analytical analysis of data, and/or the like. In that regard, the task may comprise any suitable task, event, job, and/or processing of computer data in system 100. In various embodiments, the task may comprise one or more features (e.g., subtasks). For example, where the task comprises analyzing data, a first feature may comprise retrieving data (from one or more data sources across various data structures), a second feature may comprise analyzing the data, a third feature may comprise generating an output of the analyzed data, a fourth feature may comprise transmitting the output of the analyzed data (e.g., to another feature), and/or the like.

Each task and/or feature may comprise at least one functional component and at least one data component. The functional components may comprise information indicating the code needed to execute for each task and/or feature. For example, the functional components may comprise information indicating the metadata, identifier, etc. of the code. In various embodiments, the functional components may also comprise information indicating a specific code container 143 to execute (e.g., via code container ID, or the like). The data components may comprise information indicating the data needed to complete each task and/or feature. For example, the data components may comprise information indicating the metadata, identifier, key, etc. of the data. In various embodiments, the data components may also comprise information indicating a specific data container 153 (e.g., via data container ID, or the like). In various embodiments, each data component may correspond to a functional component and may indicate the data needed for each individual code specified in the functional components.

In various embodiments, feature processor 120 may be in electronic and/or logical communication with master coordinator 110, data inventory 130, and/or code container environment 140. Feature processor 120 may comprise any suitable combination of hardware and/or software. Feature processor 120 may comprise a computer-based system, processor, or the like capable of receiving data (e.g., the task request), parsing the data to determine data attributes (e.g., parsing the task request to determine features and functional components and data components), retrieving data (e.g., code containers 143, data containers 153, data from database environment 135, etc.), and transmitting data, as discussed further herein. Feature processor 120 may comprise a virtual partition of master coordinator 110, or may comprise a physically and logically distinct processor. In that regard, feature processor 120 may include one or more processors and/or one or more tangible, non-transitory memories and be capable of implementing logic. In various embodiments, feature processor 120 may comprise a processor configured to implement various logical operations in response to execution of instructions, for example, instructions stored on a non-transitory, tangible, computer-readable medium. Feature processor 120 may also be configured to perform various logical operations in response to receiving commands from master coordinator 110, as discussed further herein.

In various embodiments, data inventory 130 may be in electronic and/or logical communication with master coordinator 110, database environment 135, and/or data container environment 150. Data inventory 130 may comprise any suitable combination of hardware, software, databased, or the like. Data inventory 130 may comprise a virtual partition of master coordinator 110, or may comprise software installed on master coordinator 110, such as, for example a database abstraction layer. Data inventory 130 may also comprise a physically and logically distinct module configured to receive data from feature processor 120 (e.g., data components), query and retrieve data from data container environment 150 and/or database environment 135, and/or transmit data, as discussed further herein. Data inventory 130 may also be configured to perform various logical operations in response to receiving commands from master coordinator 110, as discussed further herein.

Data inventory 130 may be configured to store, maintain, and update information regarding data containers 153 in data container environment 150. For example, data inventory 130 may store identifiers for each data container 153 (e.g., a data container ID or the like). Data inventory 130 may also be configured to store metadata, keys, or a similar data identifier, based on the data stored in each data container 153. In that respect, data inventory 130 may store, maintain, update, and track the available data containers 153 in data container environment 150, and the available data in each data container 153. Data inventory 130 may also be configured to store, maintain, and update information regarding database environment 135. For example, data inventory 130 may store identifiers for all the data located in database environment 135, such as, for example, metadata, keys, or other similar data identifiers.

In various embodiments, database environment 135 may comprise any suitable data structure, database, or the like disclosed herein or known in the art. Database environment 135 may comprise one or more databases, data sources, or the like. For example, database environment 135 may comprise sources of data relating to a business process. For example, database environment 135 may comprise objects generated for business needs, such as, tables merging data from various structured, semi-structured, and/or unstructured sources; merged files; merged databases; customized alerts, dashboards, and/or reports; dynamic monitoring based on intertwined data from multiple environments; data transmission and/or migration; and/or the like. In various embodiments, database environment 135 may also comprise sources of data related to financial and/or transactional systems and processes, such as, for example, a merchant submission system, a settlement database, an accounts receivable database, and/or the like.

Database environment 135 may also comprise a big data environment and/or a distributed computing cluster. As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A record of charge (or “ROC”) may comprise any transaction or transaction data.

The ROC may be a unique identifier associated with a transaction. Record of Charge (ROC) data includes important information and enhanced data. For example, a ROC may contain details such as location, merchant name or identifier, transaction amount, transaction date, account number, account security pin or code, account expiry date, and the like for the transaction. Such enhanced data increases the accuracy of matching the transaction data to the receipt data. Such enhanced ROC data is NOT equivalent to transaction entries from a banking statement or transaction account statement, which is very limited to basic data about a transaction. Furthermore, a ROC is provided by a different source, namely the ROC is provided by the merchant to the transaction processor. In that regard, the ROC is a unique identifier associated with a particular transaction. A ROC is often associated with a Summary of Charges (SOC). The ROCs and SOCs include information provided by the merchant to the transaction processor, and the ROCs and SOCs are used in the settlement process with the merchant. A transaction may, in various embodiments, be performed by a one or more members using a transaction account, such as a transaction account associated with a gift card, a debit card, a credit card, and the like.

A distributed computing cluster may be, for example, a HADOOP® cluster configured to process and store big data sets with some of the nodes comprising a distributed storage system and some of the nodes comprising a distributed processing system. In that regard, distributed computing cluster may be configured to support a HADOOP® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

In various embodiments, code container environment 140 may be in electronic and/or logical communication with feature processor 120 and/or correlation processor 160. Code container environment 140 may comprise any suitable hardware and/or software combination. Code container environment 140 may comprise a virtual environment having various containers, modules, and/or the like, as discussed further herein. Code container environment 140 may be configured to store and maintain one or more code containers 143 (e.g., code container 143A and code container 143B). Each code container 143 may comprise an identifier (e.g., C1, C2, etc.), and may be configured to correspond to one or more tasks and/or features. Each code container 143 may comprise one or more code elements (e.g., code container 143A may comprise code elements C1(F1), C1(F2), and C1(Fn), and code container 143B may comprise code elements C2(F1), C2(F2), C2(Fn)). As used herein, “code,”, “code elements,” or the like may refer to an application programming interface (API), a web service, a script, an executable file, a microservice, an application, and/or any other suitable software-based instructions or commands configured to perform operations on data.

In various embodiments, each code container 143 may be stored as a partition, in cache, in a data structure, in the cloud, and/or the like. In various embodiments, code containers 143 may be stored based on algorithmic intelligence, artificial intelligence, and/or machine learning. For example, master coordinator 110 may monitor the selection of code containers 143 from code container environment 140, and in response to the code container 143 being selected above a predefined threshold, more than the other code containers 143 in code container environment 140, and/or the like, master coordinator 110 may command feature processor 120 to move the selected code container 143 into cache, and/or a faster access location. As a further example, master coordinator 110 may also implement machine learning to determine data locality to logically move the selected code container 143 closer to the data needed to complete the code. In that respect, code containers 143 may be moved and stored to optimize the selection and retrieval of code containers 143.

In various embodiments, code container environment 140 may comprise various modules, subcomponents, and/or the like configured to aide in maintaining code containers 143. For example, code container environment 140 may comprise a code container replicator module 145 and/or a code container kill module 147. Code container replicator module 145 and/or a code container kill module 147 may comprise any suitable combination of hardware and/or software.

Code container replicator module 145 may be configured to spawn temporary copies of one or more code containers 143. For example, in response to feature processor 120 selecting code container 143A, as discussed further herein, feature processor 120 may “lock” code container 143A until correlation processor 160 completes execution of code container 143A. For example, attributes in code container 143A may be modified to set access privileges to prevent access and editing to code container 143A. In response to feature processor 120 attempting to select code container 143A for a second task and/or feature, code container replicator module 145 may be configured to spawn a temporary copy of code container 143A such that feature processor 120 may select the spawned code container 143A. In response to correlation processor 160 completing execution of code container 143A, and feature processor 120 “unlocking” code container 143A in code container environment 140, code container replicator module 145 may be configured to remove the spawned copy from code container environment 140.

Code container kill module 147 may be configured to remove code containers 143 from code container environment 140. For example, code container kill module 147 may be configured to implement algorithmic intelligence, artificial intelligence, and/or machine learning to determine code containers 143 to remove. For example, the algorithmic intelligence useful for removing code containers 143 may be based on various parameters, such as, for example, a software support end date, data about deprecated features, etc. Machine learning may be implemented to remove code containers 143 based on usage patterns, number of faults encountered, a change in the value of a data field rendering previous code container 143 removable, or the like. For example, in response to code container 143B being out of date or a new copy of code container 143B being added to code container environment 140 (as instructed by master coordinator 110), code container kill module 147 may be configured to remove code container 143B from code container environment 140. In that regard, code container kill module 147 may delete all instances of code container 143B in code container environment 140 to remove code container 143B. Code container kill module 147 may also be configured to monitor the usage and selection of each code container 143. For example, in response to code container 143A not being selected for a predefined time period (e.g., 1 year, 6 months, etc.), code container kill module 147 may be configured to remove code container 143A from code container environment 140.

In various embodiments, data container environment 150 may be in electronic and/or logical communication with data inventory 130 and/or correlation processor 160. Data container environment 150 may comprise any suitable hardware and/or software combination. Data container environment 150 may comprise a virtual environment having various containers, modules, and/or the like, as discussed further herein. Data container environment 150 may be configured to store and maintain one or more data containers 153 (e.g., data container 153A and data container 153B). Each data container 153 may comprise an identifier (e.g., D1, D2, etc.), and may be configured to correspond to one or more tasks, features, code elements, and/or code containers. Each data container 153 may comprise one or more data elements (e.g., data container 153A may comprise data elements C1(D1), C1(D2), and C1(Dn), and data container 153B may comprise data elements C2(D1), C2(D2), C2(Dn)). Each data element may correspond to data in database environment 135, and each data element may comprise metadata, a key, and/or the like identifying the data.

In various embodiments, each data container 153 may be stored as a partition, in cache, in a data structure, in the cloud, and/or the like. In various embodiments, data container 153 may be stored based on algorithmic intelligence, artificial intelligence, and/or machine learning. For example, master coordinator 110 may monitor the selection of data container 153 from data container environment 150, and in response to a data container 153 being selected above a predefined threshold, more than the other data container 153, and/or the like, master coordinator 110 may command data inventory 130 to move the selected data container 153 into cache, and/or to a faster access location. For example, machine learning may be implemented to determine data caching strategies based on the frequency of task requests, thus a more frequently recurring task may be implemented into a quicker caching mechanism compared to a task that is less frequently requested. Machine learning may also be implemented to determine the frequency of data container 153 creation, such as, for example, based on the volume and velocity of incoming data, and the frequency of requested tasks using that data. In that respect, data container 153 may be moved and stored to optimize the selection and retrieval of data container 153.

In various embodiments, data inventory 130 may be configured to retrieve data from database environment 135, generate a data container, and/or transmit the data container for storage in data container environment 150. Master coordinator 110 may be configured to transmit commands to data inventory 130 to generate new data containers. For example, in response to data being updated in database environment 135, master coordinator 110 may transmit a command to data inventory 130 to generate a new data container comprising the updated data. System 100 may implement algorithmic intelligence, artificial intelligence, and/or machine learning to determine when to generate additional data containers. For example, master coordinator 110 may monitor the querying and selection of data containers 153 by data inventory 130. In response to repeated queries to data container environment 153 yielding no data containers, master coordinator 110 may command data inventory 130 to generate a new data container comprising the data being queried. In that respect, the creation and storage of new data containers in data container environment 150 may increase the efficiency of system 100 by enabling faster and more efficient retrieval of frequently used data.

In various embodiments, data container environment 150 may comprise various modules, subcomponents, and/or the like configured to aide in maintaining data containers 153. For example, data container environment 150 may comprise a data container replicator module 155 and/or a data container kill module 157. Data container replicator module 155 and/or a data container kill module 157 may comprise any suitable combination of hardware and/or software.

Data container replicator module 155 may be configured to spawn temporary copies of one or more data containers 153. For example, in response to data inventory 130 selecting data container 153A, as discussed further herein, data inventory 130 may “lock” data container 153A until correlation processor 160 completes use of data container 153A. For example, attributes in data container 153 may be modified to set access privileges to prevent access and editing to data container 153. In response to data inventory 130 attempting to select data container 153A for a second task and/or feature, data container replicator module 155 may be configured to spawn a temporary copy of data container 153A such that data inventory 130 may select the spawned data container 153A. In response to correlation processor 160 completing use of data container 153A, and data inventory 130 “unlocking” data container 153A in data container environment 150, data container replicator module 155 may be configured to remove the spawned copy from data container environment 150.

Data container kill module 157 may be configured to remove data containers 153 from data container environment 150. For example, data container kill module 157 may be configured to implement algorithmic intelligence, artificial intelligence, and/or machine learning to determine data containers 153 to remove. For example, in response to data container 153B being out of date or a new copy of data container 153B being added to data container environment 150 (as instructed by master coordinator 110), data container kill module 157 may be configured to remove data container 153B from data container environment 150. In that regard, data container kill module 157 may delete all instances of data container 153B in data container environment 150 to remove data container 153B. Data container kill module 157 may also be configured to monitor the usage and selection of each data container 153. For example, in response to data container 153A not being selected for a predefined time period (e.g., 1 year, 6 months, etc.), data container kill module 157 may be configured to remove data container 153A from data container environment 150.

In various embodiments, correlation processor 160 may be in electronic and/or logical communication with master coordinator 110, code container environment 140, and/or data container environment 150. Correlation processor 160 may comprise any suitable combination of hardware and/or software. Correlation processor 160 may comprise a computer-based system, processor, or the like capable of receiving data (e.g., code containers 143, data containers 153, and/or stored data from database environment 135), executing code from code containers 143 to process the data from the data containers, and generating a result set. Correlation processor 160 may comprise a virtual partition of master coordinator 110, or may comprise a physically and logically distinct processor. In that regard, correlation processor 160 may include one or more processors and/or one or more tangible, non-transitory memories and be capable of implementing logic. In various embodiments, correlation processor 160 may comprise a processor configured to implement various logical operations in response to execution of instructions, for example, instructions stored on a non-transitory, tangible, computer-readable medium. Correlation processor 160 may also be configured to perform various logical operations in response to receiving commands from master coordinator 110, as discussed further herein.

Correlation processor 160 may be configured to generate a result set. The result set may be based on the task request (e.g., the features, functional components, and data components) received by master coordinator 110. For example, the result set may be generated by executing code from each selected code container to process the corresponding data from each selected data container (and/or from database environment 135). The result set may comprise the data as formatted and requested by the task request. The result set may comprise any suitable format, such as, for example, a document (e.g., a MICROSOFT® Word® document, a MICROSOFT® Excel® document, an ADOBE® .pdf document, etc.), an SMS or other type of text message, an email, FACEBOOK® message, TWITTER® tweet and/or message, MMS, a JSON file, XML, and/or any other suitable communication format. As a further example the result set may comprise one or more data fields and associated values, as needed by the task request. For example, wherein a task request comprises data to “find the country with the highest per capita income from amongst the countries with most population,” a result set may comprise data such as, “Country=USA, Population=300,000,000, Per-Capita income=$100,000.” The result set may be transmitted, via master coordinator 110, to a user, system, or the like that originated the task request.

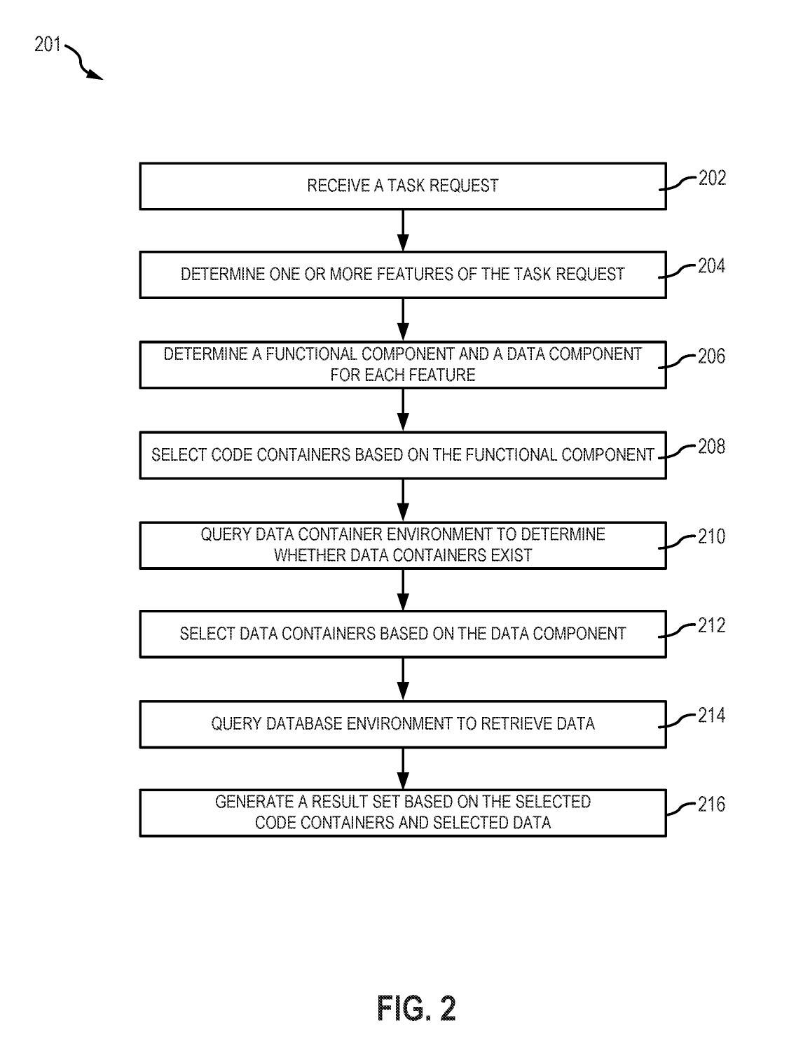

Referring now to FIG. 2 the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIG. 2, but also to the various system components as described above with reference to FIG. 1.

In various embodiments, a method 201 for executing tasks using modular code, intelligent code and data containers is disclosed. Master coordinator 110 may be configured to receive the task request (step 202). The task request may comprise one or more tasks. Feature processor 120 may be configured to determine one or more features of the task request (step 204). For example, feature processor 120 may be configured to parse the task request to determine each task and each feature corresponding to each task. Feature processor 120 may be configured to determine a functional component and a data component for each feature of the task request (step 206). For example, feature processor 120 may be configured to parse each feature to determine the functional components and data components corresponding to each feature.

In various embodiments, feature processor 120 may be configured to select code containers 143 from code container environment 140 (step 208). For example, feature processor 120 may select one or more code containers 143 based on the functional components. In that regard, each functional component may comprise metadata, identifiers, or the like indicating the code containers 143 to be selected. Feature processor 120 may query code container environment 140 based on the specified metadata, identifiers, or the like, and may select the corresponding code containers 143. In various embodiments, feature processor 120 may “lock” the code container 143 in response to selecting the code container 143 (e.g., prevent read/write access to code container 143). For example, attributes in code container 143 may be modified to set access privileges to prevent access and editing to code container 143. In response to feature processor 120 selecting a code container 143 that was previously locked, feature processor 120 may instruct code container replicator module 145 to spawn a copy of that corresponding code container 143 in code container environment 140. Feature processor 120 may transmit the selected code containers 143 to correlation processor 160. In various embodiments, feature processor 120 may also transmit code container identifying information (e.g., metadata, identifiers, etc.) to correlation processor 160, and correlation processor 160 may directly retrieve the specified code containers 143 from code container environment 140.

In various embodiments, data inventory 130 may be configured to query data container environment 150 (step 210). Data inventory 130 may query data container environment 150 based on the data components determined by feature processor 120. In that regard, each data component may comprise metadata, identifiers, or the like indicating the data containers 153, and/or data, to be selected. Data inventory 130 may query data container environment 150 based on the specified metadata, identifiers, or the like. Data inventory 130 may be configured to select data containers 153 based on the data component (step 212) from data container environment 150. Data inventory 130 may select data containers 153 in response to locating data containers 153 matching the metadata, identifiers, or the like from the data components. In various embodiments, data inventory 130 may “lock” the data containers 153 in response to selecting the data container 153 (e.g., prevent read/write access to the selected data containers 153). For example, attributes in data container 153 may be modified to set access privileges to prevent access and editing to data container 153. In response to data inventory 130 selecting a data container 153 that was previously locked, data inventory 130 may instruct data container replicator module 155 to spawn a copy of that corresponding data container 153 into data container environment 150. Data inventory 130 may transmit the selected data containers 153 to correlation processor 160. In various embodiments, data inventory 130 may also transmit data container identifying information (e.g., metadata, identifiers, etc.) to correlation processor 160, and correlation processor 160 may directly retrieve the specified data containers 153 from data container environment 150.

In various embodiments, data inventory 130 may be configured to query database environment 135 to retrieve data (step 214) in response to data inventory 130 being unable to locate data containers 153 in step 210. Data inventory 130 may query database environment 135 based on the data components determine by feature processor 120 in step 206. For example, data inventory may query database environment 135 based on the metadata, identifiers, or the like indicated in the data components. Data inventory 130 may query data container environment 150 based on the data components determined by feature processor 120. In that regard, each data component may comprise metadata, identifiers, or the like indicating the data containers 153, and/or data, to be selected. Data inventory 130 may query data container environment 150 based on the specified metadata, identifiers, or the like. In response to retrieving stored data from database environment 135, based on the specified identifier, data inventory 130 may transmit the data, via master coordinator 110, to correlation processor 160.

In various embodiments, correlation processor 160 may be configured to generate the result set (step 216). Correlation processor 160 may generate the result set based on the selected code containers and the selected data containers or data. For example, the result set may be generated by executing code from each selected code container 143 to process the corresponding data from each selected data container 153 (and/or stored data from database environment 135). The generated result list may be formatted according to any suitable specification or format discussed herein, and may be transmitted to a user, system, or the like that originated the task request.

The disclosure and claims do not describe only a particular outcome of executing tasks using modular and intelligent code and data containers, but the disclosure and claims include specific rules for implementing the outcome of executing tasks using modular and intelligent code and data containers and that render information into a specific format that is then used and applied to create the desired results of executing tasks using modular and intelligent code and data containers, as set forth in McRO, Inc. v. Bandai Namco Games America Inc. (Fed. Cir. case number 15-1080, Sep. 13, 2016). In other words, the outcome of executing tasks using modular and intelligent code and data containers can be performed by many different types of rules and combinations of rules, and this disclosure includes various embodiments with specific rules. While the absence of complete preemption may not guarantee that a claim is eligible, the disclosure does not sufficiently preempt the field of executing tasks using modular and intelligent code and data containers at all. The disclosure acts to narrow, confine, and otherwise tie down the disclosure so as not to cover the general abstract idea of just executing tasks using modular and intelligent code and data containers. Significantly, other systems and methods exist for executing tasks, so it would be inappropriate to assert that the claimed invention preempts the field or monopolizes the basic tools of executing tasks using modular and intelligent code and data containers. In other words, the disclosure will not prevent others from executing tasks using modular and intelligent code and data containers, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the system and method may include alerting a subscriber when their computer is offline. The system may include generating customized information (e.g., the result set) and alerting a remote subscriber that the information can be accessed from their computer. The alerts are generated by filtering received information, building information alerts and formatting the alerts into data blocks based upon subscriber preference information. The data blocks are transmitted to the subscriber's wireless device which, when connected to the computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer comes online.

In various embodiments, the system and method may include a graphical user interface for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., email, a result set, etc.) to prevent a computer from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which thus forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, the system may also address the problem of retaining control over customers during affiliate purchase transactions, using a system for co-marketing the “look and feel” of the host web page with the product-related content information of the advertising merchant's web page. The system can be operated by a third-party outsource provider, who acts as a broker between multiple hosts and merchants. Prior to implementation, a host places links to a merchant's webpage on the host's web page. The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A customer who clicks on an advertising link is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the customer as associated with the host web page. The server then transmits and presents this composite web page to the customer so that she effectively remains on the host web page to purchase the item without being redirected to the third party merchant affiliate. Because such composite pages are visually perceived by the customer as associated with the host web page, they give the customer the impression that she is viewing pages served by the host. Further, the customer is able to purchase the item without being redirected to the third party merchant affiliate, thus allowing the host to retain control over the customer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input, and/or any other method known in the art.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., FACEBOOK®, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE®.pdf document, etc.), an “ebook,” an “emagazine,” an application or microapplication (as described herein), an SMS or other type of text message, an email, FACEBOOK® message, TWITTER® tweet and/or message, MMS, and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the herein particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory or in-memory (non-spinning) hard drives. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The computer system or any components may integrate with system integration technology such as, for example, the ALEXA system developed by AMAZON®. ALEXA is a cloud-based voice service that can help you with tasks, entertainment, general information and more. All AMAZON® ALEXA devices, such as the AMAZON ECHO®, AMAZON ECHO DOT®, AMAZON TAP®, and AMAZON FIRE® TV, have access to the ALEXA system. The ALEXA system may receive voice commands via its voice activation technology, and activate other functions, control smart devices and/or gather information. For example, music, emails, texts, calling, questions answered, home improvement information, smart home communication/activation, games, shopping, making to-do lists, setting alarms, streaming podcasts, playing audiobooks, and providing weather, traffic, and other real time information, such as news. The ALEXA system may allow the user to access information about eligible accounts linked to an online account across all ALEXA-enabled devices.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEBSPHERE®, WEBLOGIC®, MOSS®, EDB® POSTGRES PLUS ADVANCED SERVER® (PPAS), etc.). In various embodiments, the server may include web servers (e.g. APACHE®, IIS, GWS, SUN JAVA® SYSTEM WEB SERVER, JAVA® Virtual Machine running on LINUX® or WINDOWS®).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

As those skilled in the art will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, OS2, UNIX® OS, LINUX® OS, SOLARIS®, MacOS, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16-bit integers.

Any databases discussed herein may include relational, hierarchical, graphical, blockchain, or object-oriented structure and/or any other database configurations. The databases may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT® ACCESS® or MICROSOFT® SQL Server® by MICROSOFT® Corporation (Redmond, Wash.), MYSQL® by MySQL AB (Uppsala, Sweden), or any other suitable database product. Moreover, the databases may be organized in any suitable manner, for example, as data tables or lookup tables. Each record may be a single file, a series of files, a linked series of data fields. or any other data structure.

The blockchain structure may include a distributed database that maintains a growing list of data records. The blockchain may provide enhanced security because each block may hold individual transactions and the results of any blockchain executables. Each block may contain a timestamp and a link to a previous block. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. For more information on blockchain-based payment networks, see U.S. application Ser. No. 15/266,350 titled SYSTEMS AND METHODS FOR BLOCKCHAIN BASED PAYMENT NETWORKS and filed on Sep. 15, 2016, U.S. application Ser. No. 15/682,180 titled SYSTEMS AND METHODS FOR DATA FILE TRANSFER BALANCING AND CONTROL ON BLOCKCHAIN and filed Aug. 21, 2017, and U.S. application Ser. No. 15/728,086 titled SYSTEMS AND METHODS FOR LOYALTY POINT DISTRIBUTION and filed Oct. 9, 2017, the contents of which are each incorporated by reference in their entirety.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set: e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device, or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), and symmetric and asymmetric cryptosystems. The systems and methods may also incorporate SHA series cryptographic methods as well as ECC (Elliptic Curve Cryptography) and other Quantum Readable Cryptography Algorithms under development.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® web server software, a MICROSOFT® SQL Server database system, and a MICROSOFT® Commerce Server. Additionally, components such as MICROSOFT® ACCESS® or MICROSOFT® SQL Server, ORACLE®, SYBASE®, INFORMIX® MySQL, INTERBASE®, etc., may be used to provide an Active Data Object (ADO) compliant database management system. In one embodiment, the Apache web server is used in conjunction with a Linux operating system, a MYSQL® database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT®, active server pages (ASP), common gateway interface scripts (CGI), extensible markup language (XML), dynamic HTML, cascading style sheets (CSS), AJAX (Asynchronous JAVASCRIPT® And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE® MQTM (formerly MQSeries) by IBM®, Inc. (Armonk, N.Y.) is an example of a commercially available middleware product. An Enterprise Service Bus (“ESB”) application is another example of middleware.

Those skilled in the art will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript or the like. Cryptography and network security methods are well known in the art, and are covered in many standard texts.

In various embodiments, the software elements of the system may also be implemented using Node.js®. Node.js® may implement several modules to handle various core functionalities. For example, a package management module, such as npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks (e.g., method 201, with brief reference to FIG. 2).

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is intended to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
receiving, by a master coordinator, a task request,
wherein the task request comprises a feature having functional components and data components;
retrieving, by a feature processor in electronic communication with the master coordinator, a code container based on the functional components;
querying, by a data inventory in electronic communication with the master coordinator, a data container environment,
wherein in response to locating a data container based on the data components, the data inventory retrieves the data container; and
generating, by a correlation processor in electronic communication with the master coordinator, a result set by executing code from the code container to process the data from the data container.

2. The method of claim 1, wherein the code from the code container corresponds to an application programming interface (API), a web service, a script, a microservice, or an executable file.

3. The method of claim 1, further comprising querying, by the data inventory, a database environment to retrieve stored data based on the data components in response to being unable to locate the data container based on the data components.

4. The method of claim 3, further comprising generating, by the data inventory, a second data container containing the stored data retrieved from the database environment.

5. The method of claim 1, wherein the data components comprise data metadata indicating the data to be retrieved, and wherein the data container environment is queried based on the data metadata.

6. The method of claim 1, wherein the functional components comprise code metadata indicating the code container to retrieve, and wherein the code container is retrieved based on the code metadata.

7. The method of claim 1, further comprising updating, by the master coordinator, at least one of the code container or the data container based on machine learning from generating the result set.

8. A system comprising:
a processor,
a tangible, non-transitory memory configured to communicate with the processor,
the tangible, non-transitory memory having instructions stored thereon that, in response to execution by the processor, cause the processor to perform operations comprising:
receiving, by the processor, a task request,
wherein the task request comprises a feature having functional components and data components;
retrieving, by the processor, a code container based on the functional components;
querying, by the processor, a data container environment,
wherein in response to locating a data container based on the data components, the data inventory retrieves the data container; and
generating, by the processor, a result set by executing code from the code container to process the data from the data container.

9. The system of claim 8, wherein the code from the code container corresponds to an application programming interface (API), a web service, a script, a microservice, or an executable file.

10. The system of claim 8, further comprising querying, by the processor, a database environment to retrieve stored data based on the data components in response to being unable to locate the data container based on the data components.

11. The system of claim 10, further comprising generating, by the processor, a second data container containing the stored data retrieved from the database environment.

12. The system of claim 8, wherein the data components comprise data metadata indicating the data to be retrieved, and wherein the data container environment is queried based on the data metadata.

13. The system of claim 8, wherein the functional components comprise code metadata indicating the code container to retrieve, and wherein the code container is retrieved based on the code metadata.

14. The method of claim 8, further comprising updating, by the processor, at least one of the code container or the data container based on machine learning from generating the result set.

15. An article of manufacture including a non-transitory, tangible computer readable storage medium having instructions stored thereon that, in response to execution by a computer based system, cause the computer based system to perform operations comprising:
receiving, by the computer based system, a task request,
wherein the task request comprises a feature having functional components and data components;
retrieving, by the computer based system, a code container based on the functional components;
querying, by the computer based system, a data container environment,
wherein in response to locating a data container based on the data components, the data inventory retrieves the data container; and
generating, by the computer based system, a result set by executing code from the code container to process the data from the data container.

16. The article of manufacture of claim 15, wherein the code from the code container corresponds to an application programming interface (API), a web service, a script, a microservice, or an executable file.

17. The article of manufacture of claim 15, further comprising querying, by the computer based system, a database environment to retrieve stored data based on the data components in response to being unable to locate the data container based on the data components.

18. The article of manufacture of claim 17, further comprising generating, by the computer based system, a second data container containing the stored data retrieved from the database environment.

19. The article of manufacture of claim 15, wherein the data components comprise data metadata indicating the data to be retrieved and the data container environment is queried based on the data metadata, and wherein the functional components comprise code metadata indicating the code container to retrieve and the code container is retrieved based on the code metadata.

20. The article of manufacture of claim 15, further comprising updating, by the computer based system, at least one of the code container or the data container based on machine learning from generating the result set.
